(19) United States
(12) Patent Application Publication
(10) Pub. No.: US 2017/0335761 A1
(43) Pub. Date: Nov. 23, 2017

(54) MULTI-FUEL INTERNAL COMBUSTION ENGINE, FUEL SYSTEMS AND RELATED METHODS

(71) Applicant: VERAIL TECHNOLOGIES, INC., Reno, NV (US)

(72) Inventors: Robert Nigel Horsley, Sussex (GB); Peter Paul Roosen, Nanaimo (CA); Thomas Mack, Cincinnati, OH (US)

(21) Appl. No.: 15/526,730

(22) PCT Filed: Nov. 12, 2015
(86) PCT No.: PCT/CA2015/051179

§ 371 Date: May 12, 2017

Related U.S. Application Data
(60) Provisional application No. 62/078,914, filed on Nov. 12, 2014.

(51) Int. Cl. F02B 43/12; F02M 57/06; F02M 43/04

(52) U.S. Cl. CPC F02B 43/12; F02M 43/04; F02M 57/06

(57) ABSTRACT

An internal combustion engine has fuel injectors for a first fuel and separate fuel injector-igniters for a second fuel. The first fuel may be a compression-ignition fuel such as diesel fuel while the second fuel is a lower cetane fuel that requires external energy for controlled ignition. For example, the second fuel may be natural gas. Such engines have applications in a wide range of fields, particularly those fields requiring large-displacement slow- and medium-speed engines. Such engines are particularly well adapted for use in railway locomotives. A locomotive equipped with such an engine may operate primarily on natural gas, and thereby take advantage of the significant price difference between natural gas and diesel fuel, while permitting switch over to operation on 100% diesel fuel.

### CROSS-REFERENCE TO RELATED APPLICATION

This application claims priority from U.S. Application No. 62/078,914 filed 12 Nov. 2014. For purposes of the United States, this application claims the benefit under 35 U.S.C. §119 of U.S. Application No. 62/078,914 filed 12 Nov. 2014 and entitled MULTI-FUEL INTERNAL COMBUSTION ENGINE, FUEL SYSTEMS AND RELATED METHODS which is hereby incorporated herein by reference for all purposes.

### TECHNICAL FIELD

This invention relates to internal combustion engines, particularly heavy duty low- and medium-speed engines as are used, for example, in railroad locomotives. Embodiments provide engines that may use fuel of a plurality of fuel types and components for such engines. Some embodiments may burn liquid fuels such as diesel fuel and gaseous fuels such as natural gas.

### BACKGROUND

Over the past 10 to 15 years the percentage of the total annual operating costs of railroads devoted to purchasing fuel has increased from a range of 10-15% to a range of 20-25%. In 2012, U.S. railroads individually and collectively began expressing a clear interest in using natural gas (either as liquefied natural gas (LNG) or compressed natural gas (CNG)) on a widespread basis. This interest was driven by a desire to take advantage of a large differential between the cost of diesel fuel and the cost of natural gas. Widespread use of natural gas as a fuel for locomotives has the potential to bring the fuel portion of operating costs back to 10-15%.

Over the past 10 to 15 years, while the price of diesel fuel has been increasing, domestic supplies of natural gas in the United States have been increasing due to wide scale deployment of vastly improved extraction procedures such as the combination of hydraulic fracturing (commonly known as “fracking”) and horizontal drilling. The increased supply of natural gas has made natural gas relatively inexpensive.

A problem with adopting locomotives that run on natural gas is that the infrastructure for supplying natural gas to fueling stations and the systems for fueling vehicles with natural gas are not perceived as being as reliable as the existing infrastructure for supply and fueling with diesel fuel, which is the fuel that has been used almost exclusively by U.S. railroads since the 1960's. Railroads have so far not fully exploited the very significant economic advantages of using natural gas as a fuel.

Converting existing locomotives to use natural gas or other alternative fuels is an alternative to purchasing new locomotives capable of burning such fuels. It has previously not been considered economically viable to make significant investments in rebuilding older locomotives in part because new locomotives offered significantly better fuel economy and lower emissions. Further, locomotives are generally considered to have a lifespan of about 20 years (even though a locomotive, if properly rebuilt, can last 40 to 50 years or even longer). Investing in rebuilding a locomotive that was already near the end of its expected lifespan was not considered to make sense.

The economics of rebuilding locomotives is changing, however. Due to upcoming emissions requirements, the next generation of locomotives is expected to have poorer fuel economy than previous generations of locomotive. This is due to the extensive new emission control strategies which will be required to maintain emissions below regulated limits. New engines will require exhaust gas recirculation and other strategies that adversely affect fuel economy. These emission-control technologies will also add substantial cost to new locomotives and will require additional maintenance. The durability of these new emission reduction devices is also unproven. Because of these factors, extending the life of their current locomotive fleets by rebuilding existing locomotives is becoming much more attractive and economically viable.

As noted above, most locomotives have diesel engines that run on diesel fuel. Diesel engines are also widely used in other industries. Diesel engines are favored by industry because of their excellent combination of power, performance, efficiency and reliability. For example, diesel engines are generally much less expensive to operate compared to gasoline fueled, spark-ignited engines, especially in commercial applications where large quantities of fuel are used. Diesel engines have relatively high efficiencies because they employ high compression ratios without knocking, which is caused by the premature detonation of the fuel mixture inside the combustion chamber.

Currently, the rate of worldwide distillate fuel oil consumption exceeds 25 million barrels per day according to the United States Energy Information Administration. A very large percentage of this fuel is used in diesel engines. Diesel engines currently represent a large percentage of the engines used to power off-road vehicles in the railway, marine, construction and mining industries. They are also widely used for electrical power generation, mineral and materials extraction and processing, farming and numerous other industrial applications.

Large merchant ships commonly use single very large diesel engines (some are over 100,000 horsepower) or multiple high-horsepower locomotive-size diesel engines. There has been a desire to be able to use different types of fuels in ships which are now largely standardized to burning diesel fuel or heavy fuel oils. For example, the increasingly large fleets of ships that carry liquefied natural gas (LNG) are now occasionally being built with dual fuel engines so that the cleaner and less costly LNG these ships transport in large quantities can also be used as a fuel source for the ship itself.

The oil and gas industry employs numerous engines throughout its operations. Many oil wells produce natural gas and natural gas liquid side products in varying quantities for which there are limited markets or where transportation infrastructure is insufficiently developed. Many times this natural gas is often vented or burnt on site in an industry practice referred to as “flaring”. Accordingly, there is a need to utilize these less desirable products efficiently and cost-effectively.

Diesel engines are compression-ignition engines. In a diesel engine, diesel fuel is introduced directly at high pressure into a combustion chamber through an injector mounted in the cylinder head. The high-pressure injection atomizes the fuel for efficient combustion.

A major disadvantage of diesel engines is that they are not well suited to using fuels with low cetane numbers, such as cetane numbers below 40. The preferred range of acceptable cetane ratings is nominally in the range of 40 to 55, with a maximum of about 60. Natural gas fuels (LNG and CNG) have very low cetane numbers.

Another disadvantage of diesel engines is pollution, such as particulate matter (PM, commonly known as soot) and gaseous oxides of nitrogen (NOx), which are subject to increasingly stringent regulations. To comply with these tightening regulations, engine manufacturers are developing selective catalytic reduction (SCR) systems and other after-treatment devices to remove pollutants from diesel fuel exhaust streams. Carbon dioxide (CO2) emissions, often described as a greenhouse gas, are also considered to be a pollutant and therefore targeted for reduction.

Improvements to diesel fuels are also being introduced to reduce the amount of sulfur in diesel fuel, to prevent sulfur from de-activating the catalysts of SCR systems and to reduce air pollution. Research is also being conducted to improve combustion efficiency to reduce engine emissions, for example by making refinements to engine control strategies. However, most of these approaches add to the capital and/or operating costs of the engine.

There is a need for engines capable of burning natural gas or other alternative fuels suitable for use in railway locomotives and other applications which address obstacles that have so-far prevented the widespread adoption of such fuels.

There is a general desire to extend the life of current locomotive fleets while lowering fuel costs and improving emissions. In particular, there is a desire for a way to convert existing locomotives to reliably and efficiently run on alternative fuels such as natural gas.

The foregoing examples of the related art and limitations related thereto are intended to be illustrative and not exclusive. Other limitations of the related art will become apparent to those of skill in the art upon a reading of the specification and a study of the drawings.

### SUMMARY

The invention has a number of different aspects. These include, without limitation:
engines that can operate both on diesel fuel and natural gas,
railway locomotives capable of operating on both diesel fuel and natural gas,
cylinder heads having fuel injectors for diesel fuel and fuel injectors for natural gas,
fuel systems for engines that can switch between supplying diesel fuel and natural gas to run the engines,
methods for operating engines,
methods for modifying existing diesel engines to run either diesel fuel and natural gas; and
methods for modifying existing locomotives to run on natural gas.

One example aspect provides a cylinder head for use in an internal combustion engine. The cylinder head comprises separate injectors for a plurality of different fuels. In some embodiments one of the fuels is a liquid fuel and one of the fuels is a gaseous fuel. In a particular example embodiment, the cylinder head is configured with one or more injectors for natural gas and at least one injector for diesel fuel. The natural gas injectors may comprise igniters powered by an external energy source and operable to ignite natural gas. In some embodiments the igniters use laser to initiate combustion of the natural gas or other fuel. In some embodiments the igniters use electrically-generated sparks or other sources of concentrated energy to initiate combustion of the natural gas or other fuel.

In some embodiments the cylinder head is equipped with two different injection systems for natural gas or other gaseous fuel. One injection system may inject high-pressure gaseous fuel, The other injection system may inject the same gaseous fuel at a significantly lower pressure. The higher-pressure injection system may comprise an injector-igniter as described above. The lower-pressure injection system may inject the gaseous fuel at a lower pressure. In such an embodiment a pressure boost system may be provided to bring pressure up to the high pressure (e.g. a pressure in excess of 2000 psi such as 5,000 psi or a pressure in the range of 3000 psi to 10000 psi) used by the higher-pressure ignition system (e.g. injector/igniter(s)). An advantage of such embodiments is that the pressure boost system does not need to be sized to boost pressure of all of the gaseous fuel but may be sized to have a capacity sufficient for the higher-pressure ignition system only.

In some embodiments timing of the higher-pressure and lower-pressure injection systems may be different. For example, the lower-pressure injection system may be operated to inject the gaseous fuel into a cylinder early, while cylinder pressures are relatively low. The higher-pressure injection system could operate later in the cycle when cylinder pressures are higher at a time when it is desired to initiate combustion within the cylinder.

The volume of gaseous fuel introduced by the higher- and lower-pressure injection systems may be individually controlled such that a desired total volume of the gaseous fuel is injected each cycle. In some embodiments the lower-pressure injection system is controlled to inject more of the gaseous fuel than the higher-pressure injection system. In some embodiments the lower-pressure injection system is controlled to inject 35 to 70% of the total gaseous fuel in each cycle. In some embodiments the lower-pressure injection system is controlled to limit the amount of injected gaseous fuel to a level lower than a knock threshold (the knock threshold is the amount of gaseous fuel above which significant knock may occur). The amount of gaseous fuel injected by the higher-pressure injection system may be controlled to avoid knock problems.

A cylinder head according to any embodiment of the above aspect may operate in conjunction with two or more fuel systems which can be operated independently of one another such that an engine equipped with such cylinder heads and fuel systems may be run entirely on either a first fuel (e.g. diesel fuel) and/or a second fuel (e.g. natural gas). Some embodiments may provide cooperative modes in which both fuel systems are in operation at the same time. Cylinder heads according to this aspect may be made by modifying existing cylinder heads (e.g. an existing diesel engine cylinder head) to include one or more injector-igniters in addition to an existing diesel fuel injector. In other embodiments, cylinder heads according to this aspect are built for the purposes described herein.

In some embodiments, the cylinder head includes one or more injector-igniters for an alternative fuel in addition to an injector for a liquid fuel. The liquid-fuel injector may be located to inject fuel at the center of a combustion chamber. The injector-igniters may be arranged symmetrically around the liquid-fuel injector or may have an asymmetric arrangement. In some embodiments, the injector-igniters are angled relative to a face of the cylinder head. In such embodiments, bodies of the injector-igniters may project outwardly on one side of the cylinder head. Such embodiments can be advantageous in that the injector-igniters may be positioned so as not to interfere with other engine components and not to interfere with the function of other components in the cylinder head (e.g. valves, coolant passages, air intake channels, exhaust channels etc.).

Another example aspect of the invention provides a method for converting an engine to run on one or both of two types of fuel using two independently-operable fuel systems. Such a conversion may include replacing cylinder heads of the engine with cylinder heads as described above, installing a fuel storage tank, fuel lines connecting the fuel storage tank to deliver fuel to the injector-igniters, and a control system which may comprise a fuel system controller, sensors, regulators etc. The method may additionally comprise modifying an existing diesel fuel injection system to allow the diesel fuel injection system to be disabled such that the converted engine may be run entirely on an alternative fuel such as natural gas and may also be switched back to run entirely on diesel fuel.

Another example aspect of the invention provides a locomotive having an engine comprising two independently-operable fuel systems that permit the engine to run on either or both of two types of fuel. The locomotive may automatically switch between one fuel type, the other fuel type and some combination of the two fuel types based on desired emissions, reliability, power and other factors. Switching may be performed manually in some embodiments. In some embodiments, not all injector-igniters are configured to ignite on each power stroke for low speed or low power usage such as idling.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced Figures of the drawings. It is intended that the embodiments and Figures disclosed herein are to be considered illustrative rather than restrictive.

FIG. 1 is a perspective view of an example prior art cylinder head of a typical medium-speed diesel engine. The cylinder head includes a diesel fuel injector located centrally relative to a combustion chamber.

FIG. 2 is a perspective view of a cylinder head according to an example embodiment of the invention which includes two injector-igniters each mounted at an angle so that the distal portions of the injector-igniters project from sides of the cylinder head.

FIG. 3 is a cross-sectional view of a three-injector cylinder head, piston and engine cylinder according to an example embodiment of the invention. In this embodiment one diesel fuel injector and two injector-igniters are mounted to extend generally perpendicularly to a face of the cylinder head.

FIG. 4 is a cross-sectional view of a three-injector cylinder head, piston and engine cylinder according to an example embodiment of the invention. The cylinder head has one diesel fuel injector having a centerline extending perpendicularly to a face of the cylinder head and two injector-igniters mounted at angles to the face of the cylinder head such that distal portions of the injector-igniters project from opposing sides of the cylinder head.

FIG. 5 is a diagrammatic representation of a possible fuel jet/combustion pattern produced by the injector-igniters shown in FIG. 3 as seen looking toward the cylinder head from the piston.

FIG. 6 is a diagrammatic representation of a possible fuel jet/combustion pattern produced by the injector-igniters shown in FIG. 4 as seen looking toward the cylinder head from the piston.

FIG. 7 is a diagrammatic representation of an alternative fuel jet/combustion pattern.

FIG. 8 is a diagrammatic representation of an example fuel jet/combustion pattern for a cylinder head equipped with four injector-igniters.

FIG. 9 is a diagrammatic representation of another alternative fuel jet/combustion pattern.

FIG. 10 is a cross-sectional view of a three injector cylinder head, piston and engine with one diesel fuel injector centrally mounted in a combustion chamber, one injector-igniter mounted so that its centerline is perpendicular to a face of the cylinder head, and one injector-igniter mounted at an angle to the face of the cylinder head such that a distal portion of the injector-igniter projects from a side of the cylinder head.

FIG. 11 is a diagrammatic representation of a fuel jet/combustion pattern that may be produced by the injector-igniters shown in FIG. 10 as seen looking toward the piston.

FIG. 12 is a diagrammatic top plan view representation of an engine including a group of three cylinder heads of the type shown in FIG. 1 with interleaved angled injector-igniters as shown in FIG. 7.

FIG. 13 is a schematic illustration of an engine system having two fuel systems according to an example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The invention may be applied to provide a multi-fuel engine having two separately-operable fuel systems. The engine may operate according to any suitable cycle. For example, the engine may be a four-stroke engine or a two-stroke engine. In some embodiments, one fuel system is connected to deliver a fuel that can be ignited by compression, such as diesel fuel, while the other fuel system is connected to deliver a fuel that requires externally-sourced energy such as a spark, laser or another external ignition source. The second fuel may, for example, comprise a gaseous fuel such as natural gas. In other embodiments, the second fuel may comprise a fuel such as methanol, reformed methanol, alkane fuels such as any of ethane, propane, butane up to and including liquid pentane, hexane etc., syngas, biodiesel fuel, biofuels or blends of the above. In further embodiments, heavy fuel oils or coal derivatives may be used as fuels.

A multi-fuel engine as described may advantageously be operated on either fuel. For example, the engine may be run on a gaseous fuel. If there is a problem, such as a lack of gaseous fuel, a problem with a fuel filling station, or the like, then the engine may be switched over to run on another fuel, such as diesel fuel, for example. Where the engine is a locomotive engine, this capability may be exploited to quickly and easily revert the locomotive to full diesel fuel mode operation so that if there is any interruption of gas supply, the railroad can keep trains moving without disruption.

Each of the fuel systems may be configured to directly inject the corresponding fuel into the engine cylinder, for example by way of one or more fuel injectors. Fuel injectors for the two fuel systems may be separate from one another. Various arrangements of the fuel injectors are possible.

In some embodiments, the fuel injectors for the fuel that requires a spark or another external ignition source may comprise injector-igniters. Injector-igniters provide both injection of the fuel into a combustion chamber and also supply energy for ignition of the fuel (in the form of a spark or otherwise). Providing at least one fuel system which includes injector-igniters facilitates the use of alternative fuels such as LNG or CNG that have low cetane numbers, such as cetane numbers below 40. Such fuels typically require positive ignition, such as a spark or heat generated by a laser, plasma or other energy source. Injector-igniters may also be used with fuels which do not require positive ignition. Non-limiting examples of injector-igniters that may be applied in some embodiments are described in U.S. Pat. No. 8,635,985 entitled Integrated Fuel Injectors and Igniters and Associated Methods of Use and Manufacture which is hereby incorporated herein by reference.

In some embodiments, one or more injector-igniters comprise a laser igniter and/or are used in conjunction with one or more laser igniters. Any embodiment described herein which includes an injector-igniter may be modified to yield another example embodiment by replacing the injector-igniter with one or more injectors and one or more laser igniters. Non-limiting examples of laser igniters that may be applied in some embodiments are described in U.S. Pat. No. 7,421,166 entitled Laser Spark Distribution and Ignition System, US Patent Application No. 2013/0186362 entitled Laser Ignition System and US Patent Application No. 2006/0243238 entitled Laser Type Engine Ignition Device which are all hereby incorporated herein by reference.

In engines according to some embodiments a first fuel system is a conventional diesel fuel injection system. The diesel fuel injection system may be used to run the engine as a diesel engine. While the engine is running as a diesel engine the other fuel system may be inoperative. Similarly, the diesel fuel system may be disabled and the second fuel system enabled such that the engine may operate entirely on an alternative fuel such as natural gas or other gaseous fuel.

A pre-existing internal combustion engine such as a diesel engine may be modified to permit operation as a multi-fuel engine as described herein. The modification may, for example, comprise replacing cylinder heads of the engine with cylinder heads as described herein which include both a fuel injector for a first fuel, such as diesel fuel and one or more injector-igniters for a second fuel such as LNG or CNG. Additional steps in the modification include providing a source of the second fuel, plumbing fuel lines to deliver the second fuel to the engine, and providing a controller configured to control the injector-igniters to inject and ignite the second fuel.

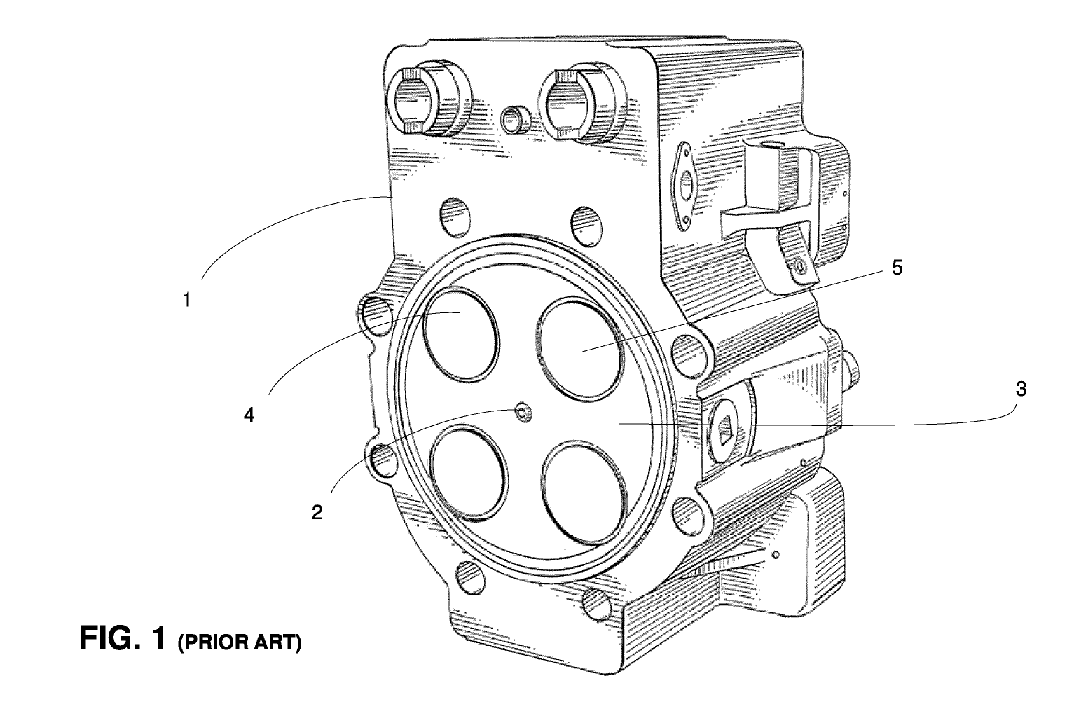

FIG. 1 depicts a cylinder head 1 of the type typically used in low- or medium-speed diesel engines. Cylinder head 1 has a diesel fuel injector 2 located centrally in a combustion chamber 3. Intake valves 4 and exhaust valves 5 are provided in combustion chamber 3. The illustrated cylinder head is an example only of one type of cylinder head that may be modified to provide a cylinder head according to an embodiment of the invention. However, the invention is not limited to cylinder heads of the exact type shown in FIG. 1. Details of the design of cylinder heads vary from engine to engine. Many types of cylinder heads may be modified according to embodiments of the invention.

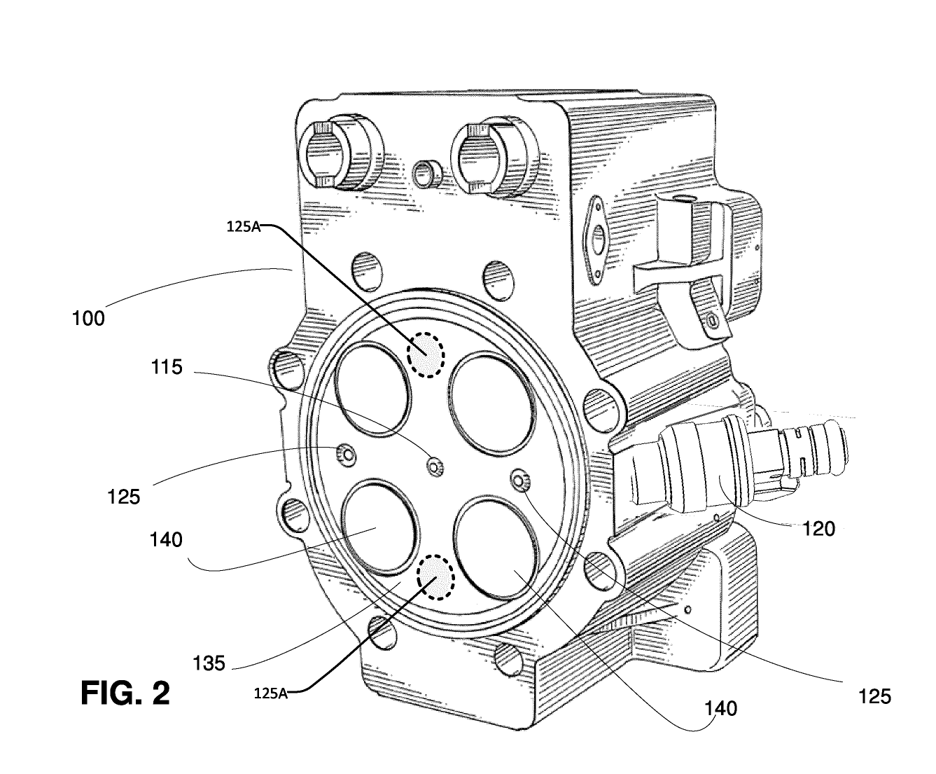

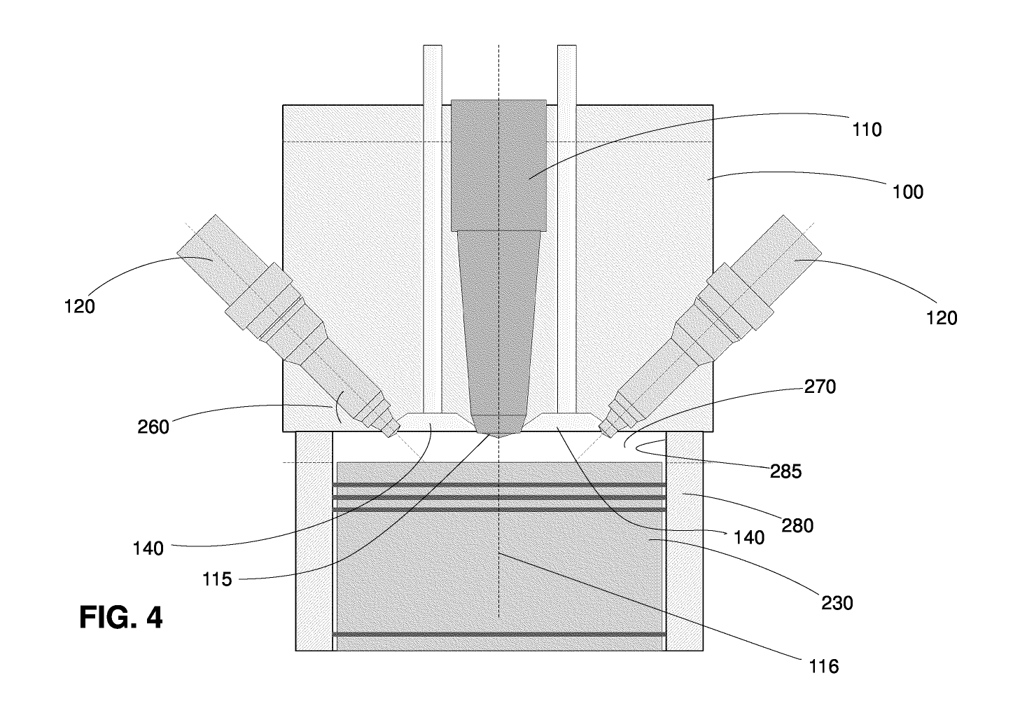

FIGS. 2 and 4 depict a cylinder head 100 according to an example embodiment. Cylinder head 100 may be either a retrofitted cylinder head from a pre-existing engine or a cylinder head built for the purposes described herein. Cylinder head 100 comprises two injector-igniters 120 and one diesel fuel injector 110. Cylinder head 100 includes combustion surface 135 through which tip 115 of diesel fuel injector 110 and tips 125 of two injector-igniters 120 are exposed. As illustrated in FIG. 2, diesel fuel injector tip 115 may be located centrally on combustion surface 135 of cylinder head 100.

FIG. 2 also shows two optional low-pressure gaseous fuel injectors 125A. In some embodiments gaseous fuels are injected both through injector igniters 120 and low-pressure gaseous fuel injectors 125A.

Cylinder head 100 may be mounted to an engine to close off cylinder 280, as depicted, for example, in FIG. 4. Cylinder 280 includes interior cylinder wall 285 which, together with cylinder head 100 and piston 230 defines combustion chamber 270. In the illustrated embodiment, cylinder 280 has a longitudinal axis 116. The tip 115 of diesel fuel injector 110 lies on or near axis 116.

Diesel fuel injector 110 may be any type of diesel fuel injector as is known in the art. In embodiments where cylinder head 100 is being retrofitted to an existing engine, diesel fuel injector 110 may optionally comprise a diesel fuel injector that is stock for that engine as provided on unmodified examples of the engine.

A diesel fuel system, including diesel fuel injector 110 may be operable completely independently of injector-igniters 120. Where an existing diesel engine is being modified according to the invention, a diesel fuel system of the engine may have few or no modifications other than a way to disable the diesel fuel system if not already provided.

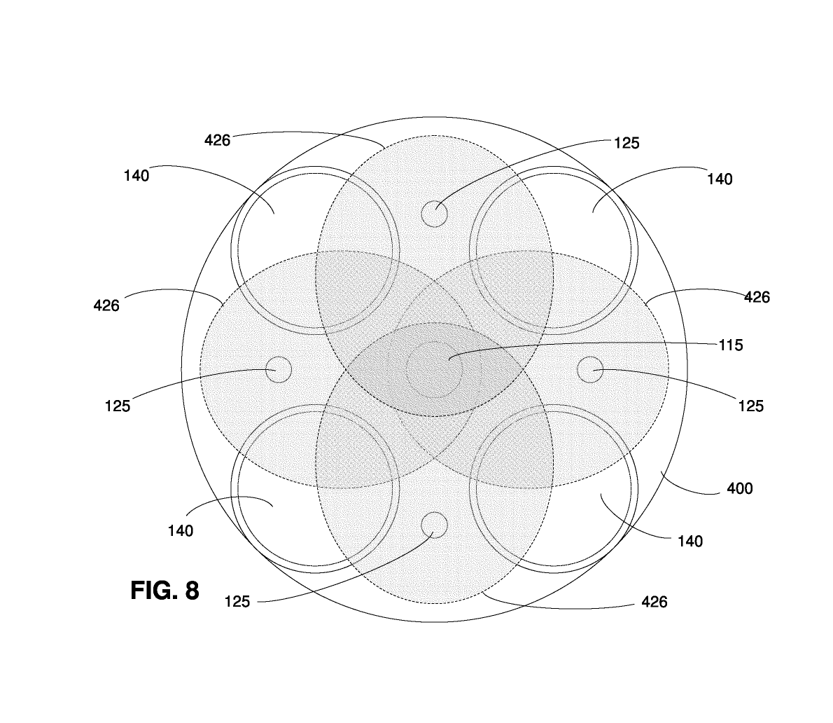

In some embodiments, one injector-igniter is provided while in others, more than one injector-igniter is provided. FIG. 2 depicts an example cylinder head 100 having two injector igniters 120. FIG. 8 depicts an example cylinder head 400 having four injector igniters 120. Other embodiments provide cylinder heads equipped with other numbers of injector-igniters 120. In some cases, the number of injector-igniters that can be provided in a cylinder head is limited by spatial constraints. In some embodiments, one, two or more low-pressure gaseous fuel injectors 125A are provided in addition to one, two or more injector-igniters 120.

In some embodiments a plurality of injector-igniters are arranged such that their tips are approximately equidistant from one another at locations spaced apart around a circle concentric with the combustion chamber.

As the number of injector-igniters increases, the amount of fuel to be delivered by each injector-igniter decreases. Providing a larger number of injector-igniters may permit using smaller injector-igniters which may make it easier to fit the injector-igniters into a cylinder head without interfering with proper functioning of the cylinder head. Decreasing the proportion of fuel delivered by each injector-igniter may also allow the fuel to be delivered faster and later in the power stroke, thereby potentially reducing premature ignition (knocking). Furthermore, in situations where one or more injector-igniters fail, remaining injector-igniters may be sufficient to continue powering the cylinder until the engine can be repaired. The sizes of injector-igniters 120 may be further reduced if some fuel is supplied by way of one or more lower-pressure gaseous fuel injectors 125A.

In the illustrated embodiment, injector-igniters 120 of cylinder head 100 are located symmetrically about the center of combustion surface 135. The symmetry of injector-igniters 120, while not mandatory is advantageous because it contributes to balanced combustion which assists in preventing undue stress on piston 230 and inner cylinder walls 285. Balanced combustion may be important for efficiency and long term durability especially in engines which operate at higher RPM. In the illustrated embodiment, lower-pressure gaseous fuel injectors 125A are also located symmetrically about the center of combustion surface 135.

In some embodiments two injector-igniters are located along a diameter of the combustion chamber such that intake valves 4 and exhaust valves 5 respectively lie on opposing sides of the diameter. In some embodiments, the tip of each injector-igniter lies between a pair of valves.

The spacing of injector-igniters 120 may be varied. In some embodiments, injector-igniters 120 are located close to the center of combustion surface 135 while in other embodiments, injector-igniters are located near to the outside of combustion surface 135. As injector-igniters are moved away from the center of combustion surface 135, it may be beneficial to angle their tips toward the center of combustion surface 135 (as depicted in FIGS. 2 and 4) to direct inject fuel toward the center of the combustion chamber. Positioning injector-igniters 120 toward the outside of cylinder head 100 can be advantageous if there is not enough space for them to be mounted a sufficient distance from existing intake and exhaust valves 140 if located more centrally. Placing injector-igniters 120 away from the center of combustion surface 135 may allow more room to mount injector-igniters 120. Also providing passages to receive injector-igniters 120 farther from the center of combustion chamber 270 may result in reduced stress on cylinder head 100.

In some embodiments maintaining symmetry in the locations of injector-igniters 120 and directing the injected fuel toward the center of combustion chamber 270 is less important. For example, in large engines where speeds are low and pistons are usually connected to a crankshaft indirectly (e.g. by way of a crosshead), it is less important to have the fuel injected at or close to the center of combustion chamber 270 to help keep the combustion forces balanced across the top of the piston.

As depicted in FIGS. 2 and 4, injector-igniters 120 may be mounted at an injector angle 260 to the face of cylinder head 100. Injector angle 260 can vary between zero and 90 degrees. Embodiments where injector-igniters 120 are angled to direct injected fuel away from cylinder wall 285 are advantageous since directing injected fuel to impinge directly on the relatively cool cylinder wall 285 can tend to cool the injected fuel “bubble” prematurely. This can reduce efficiency of the engine.

Injector-igniters 120 may be fitted into cylinder heads designed to fit existing engines or incorporated into new engine designs by selecting injector angles 260 and positions for injector-igniter tips 125 that accommodate injector-igniters 120 without interfering with the operation of water jackets, installation bolts and sleeves in the cylinder head assembly, valves and valve actuators, intake and exhaust passages etc. Mounting injector-igniters 120 at a particular injector angle 260 may also keep mechanical stresses within safe limits. Injector angle 260 may be chosen to minimize impingement of existing structures, such as exhaust manifolds where air flows would be disrupted by the presence of an injector-igniter 120. It is not required that angles 260 be the same for all injector-igniters in a cylinder head 100.

In some embodiments, such as where laser igniters are employed, angle 260 may be different than the angle at which the spark/laser exits the laser igniter. This may allow the igniters to be mounted at an angle 260 within the cylinder head to maximize use of the cylinder head space while still allowing the laser to enter the combustion chamber at an appropriate angle for optimal combustion. In some embodiments, a single laser igniter may produce a plurality of laser ignition beams either simultaneously or at different times to improve combustion.

In some embodiments the bodies of one or more injector-igniters pass through a cooling channel. This helps to keep the body of the injector-igniter cool. In such embodiments, appropriate seals may be provided to prevent leakage of coolant along the body of the injector-igniter.

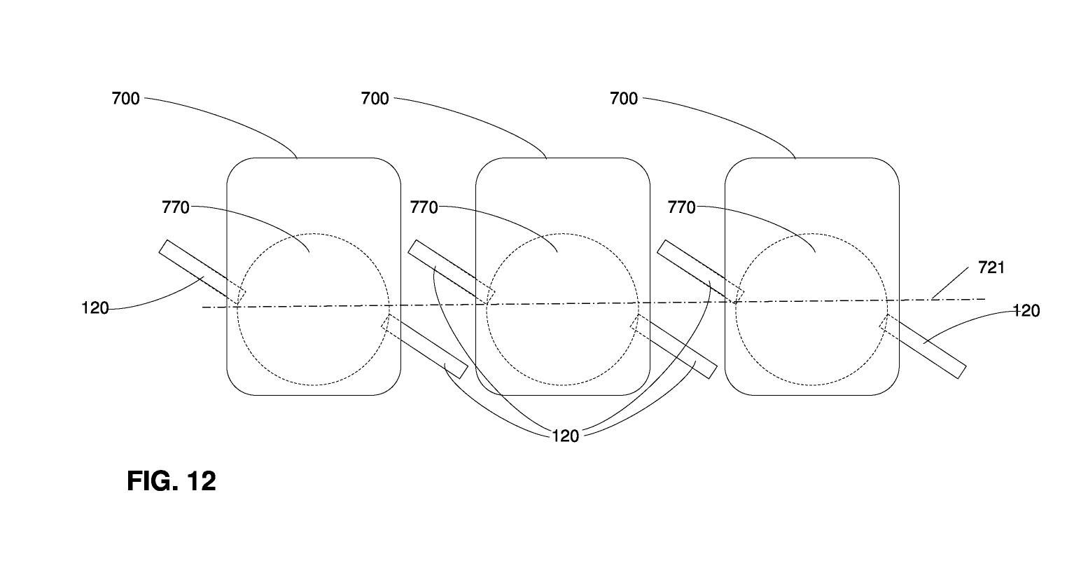

On multi-cylinder engines, injector-igniters 120 must be located such that injector-igniters for adjacent cylinders do not interfere with one another. In larger engines it is common to provide separate cylinder heads for each cylinder. These cylinder heads may be spaced apart from one another by small distances (e.g. only a few inches or cm). In such cases injector igniters 120 may still be mounted so that they project laterally from the cylinder heads. The injector-igniters may be angled to provide clearance between the bodies of the injector-igniters. In some embodiments the injector-igniters are angled such that the bodies of injector-igniters on adjacent cylinders are interleaved with one another, as illustrated for example in FIG. 12 which shows injector-igniters 120 projecting from cylinder heads 700. This construction can allow side-mounted injector-igniters to be added to an existing engine structure and may allow the injector-igniters to be more accessible for purposes of repairing or replacing.

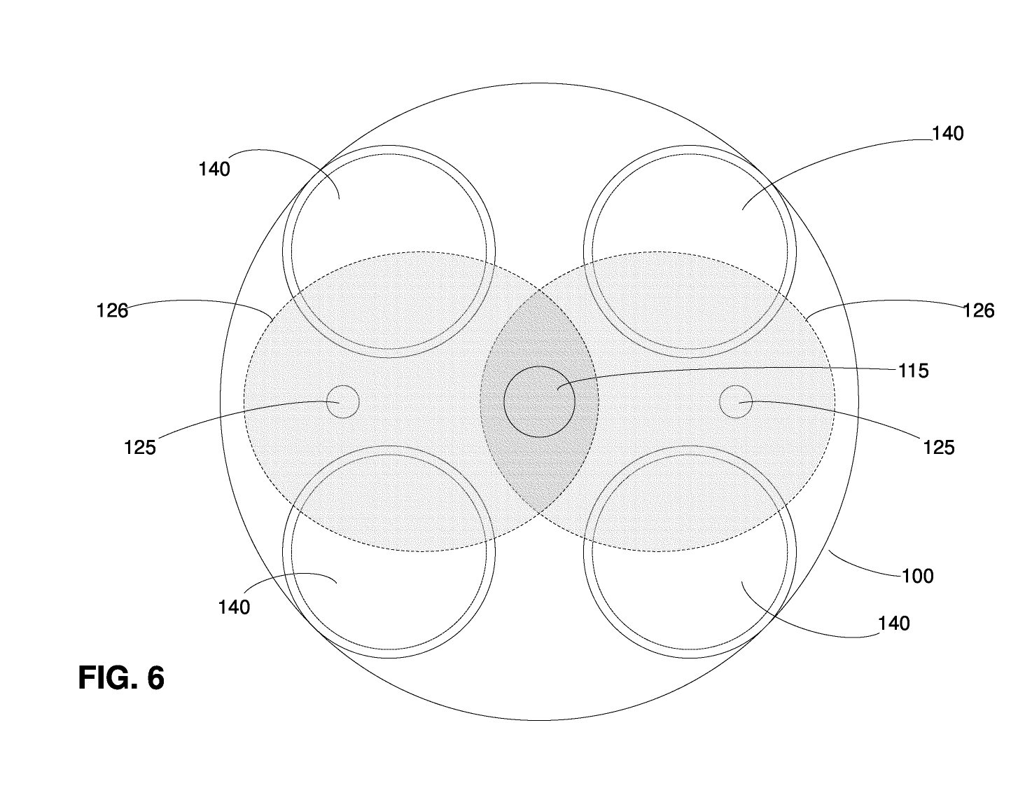

FIG. 6 shows an example fuel jet/combustion pattern 126 produced by injector-igniters 120. Fuel jet/combustion pattern 126 is a cross-section, taken in a plane that is orthogonal to the longitudinal axis of cylinder 280, of the jet produced by injector-igniters 120. Since injector-igniters 120 are angled toward the longitudinal axis of combustion chamber 270, injector-igniters 120 each produce fuel jet/combustion patterns 126 having elliptical cross-sections. In some embodiments, fuel jet/combustion patterns 126 of each of injector-igniters 120 may overlap at or near the axial center of combustion chamber 270, as depicted in FIG. 6.

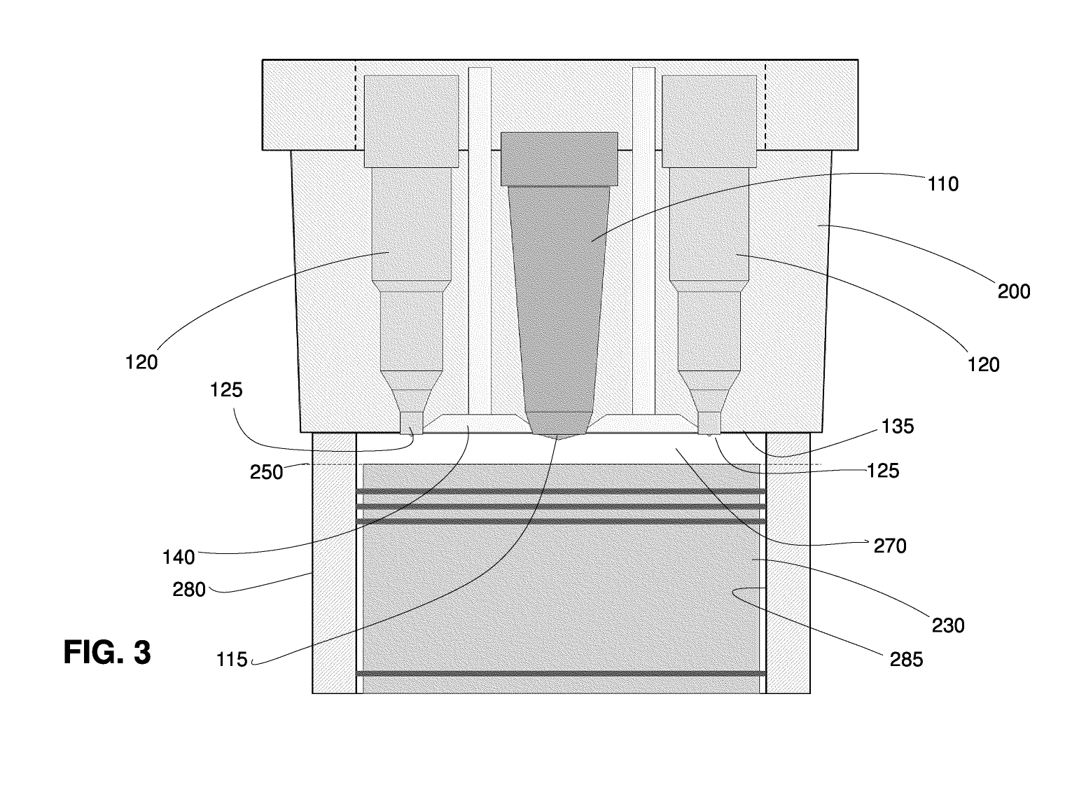

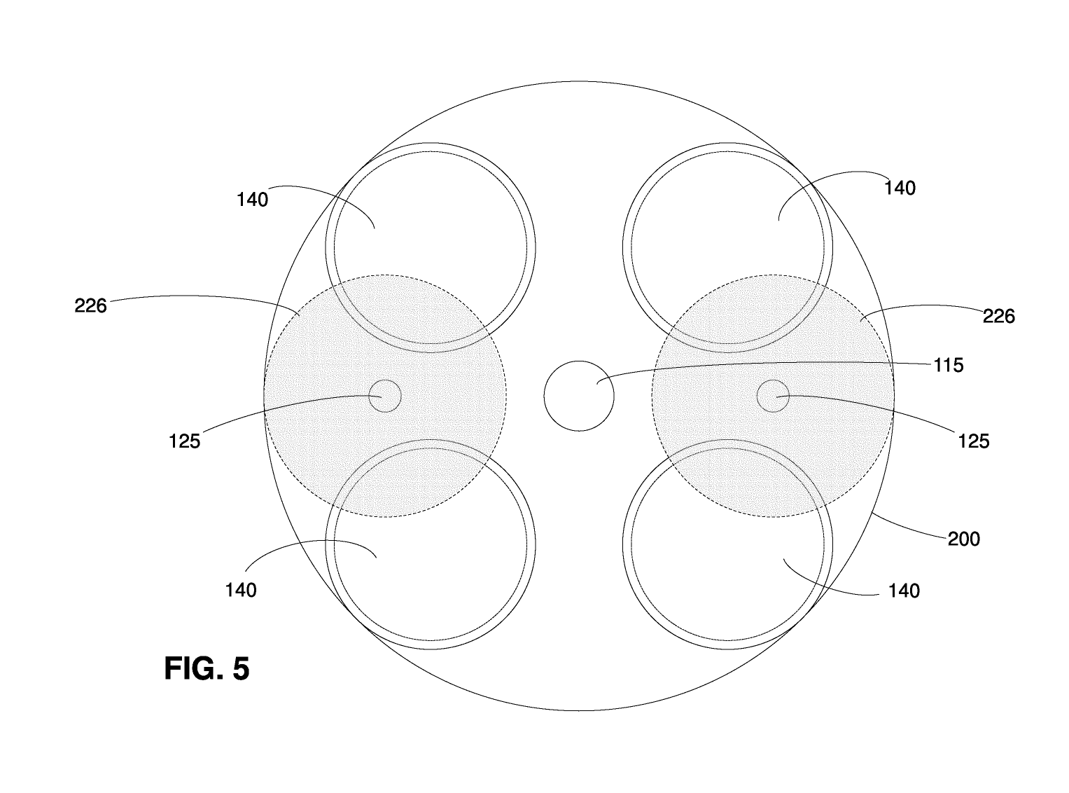

The elliptical cross-section pattern of fuel jet/combustion patterns 126 covers a larger proportion of the total cross-sectional area of combustion chamber 270 than would be the case if injector-igniters were mounted at an injector angle 260 of 90 degrees. FIGS. 3 and 5 show examples of a cylinder head 200 where injector-igniters 120 are mounted at an injector angle 260 of 90 degrees. Angling injector-igniters 120 toward the center of combustion chamber 270 therefore spreads the combustion forces throughout a larger cross-sectional area of combustion chamber 270 as compared to the embodiment shown in FIG. 5. This configuration also distributes more combustion force toward the axial center of cylinder head 100, similar to the combustion force produced by diesel fuel injected through tip 115 of diesel fuel injector 110.

FIG. 3 depicts another example cylinder head 200 which may be structurally similar to cylinder head 100 of FIG. 2 except for injector angles 260 and the corresponding mounting of injector-igniters 120.

In cylinder head 200 injector-igniters 120 are mounted so that their axes and the direction in which fuel is injected are both generally parallel to diesel fuel injector 210. Cylinder head 200 has the advantage that injector-igniters 120 on one cylinder head will not interfere with injector-igniters 120 of an adjacent cylinder head. As depicted in FIG. 3, the locations of injector-igniters 120 are selected so as not to interfere with intake and exhaust valves 240 or piston 230 at top dead center 250.

FIG. 5 shows an example fuel jet/combustion pattern 226 produced by injector-igniters 120 of cylinder head 200. Fuel jet/combustion pattern 226 is a cross-section, taken in a plane that is orthogonal to the longitudinal axis of cylinder 280, of the jet produced by injector-igniters 120. Since injector-igniters 120 have injector angle 260 equal to approximately 90 degrees (i.e. injector-igniters 120 are parallel to the axis of cylinder 280 in cylinder head 200), each injector-igniter 120 produces a fuel jet/combustion pattern 226 having a generally circular cross-section in the plane of FIG. 5. Depending on injector-igniters 120 and the amount of space in combustion chamber 270 between cylinder head 200 and piston 230 beneath it, the amount of the coverage over piston 230 can be variable.

In some embodiments, fuel jet/combustion patterns 226 of each of injector-igniters 120 may overlap at or near the longitudinal axis of combustion chamber 270. In other embodiments, such as is depicted in FIG. 5, fuel jet/combustion patterns 226 of each of injector-igniters 120 do not overlap. By arranging injector-igniters 120 appropriately, the amount of energy delivered to piston 230 can be controlled to meet or exceed the power that can be generated by burning diesel fuel supplied through diesel fuel injector 110 while not putting undue stress on piston 230 through an out-of-balance combustion event. The energy balance across piston 230 is clearly shown by circular fuel jet/combustion pattern 226 shown in FIG. 5 since fuel jet/combustion patterns 226 are symmetrical about the center of piston 230 in this example.

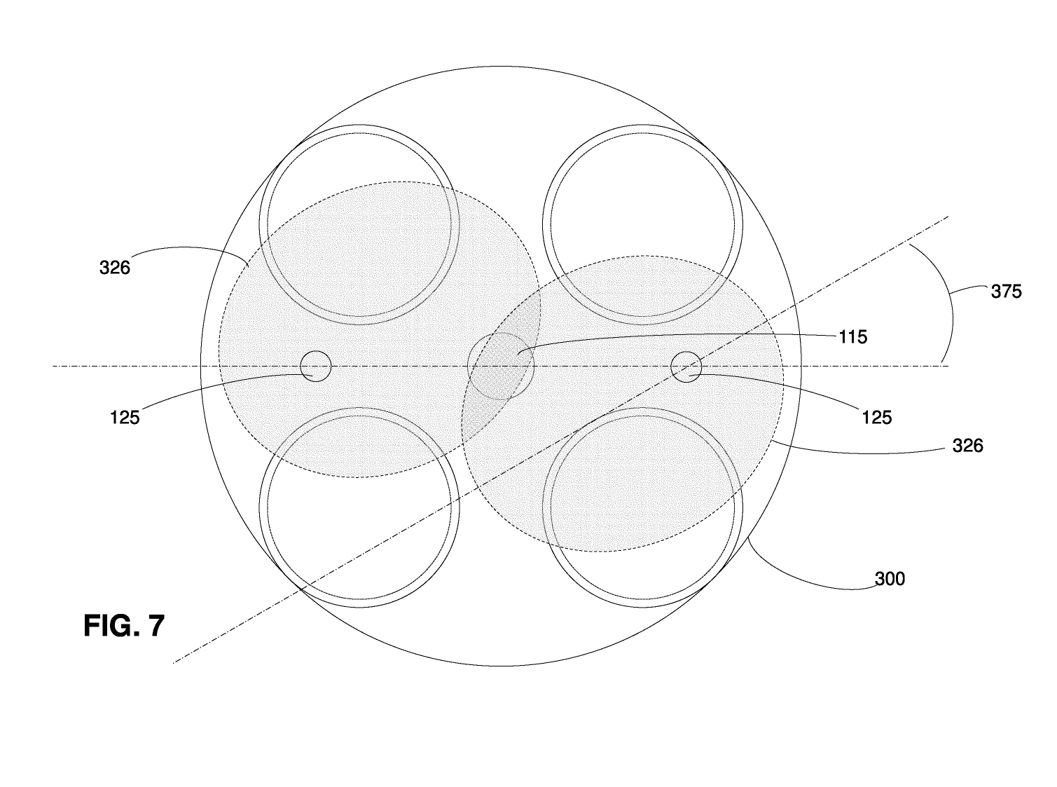

FIG. 7 depicts another example cylinder head 300. Comparison of FIGS. 6 and 7 will reveal that cylinder heads 100, 300 may be structurally similar except for the angles of injector-igniters 120 and the corresponding mounting of injector-igniters 120. In particular, in cylinder head 300, injector-igniters 320 are angled to orient their jets of injected fuel away from the center of piston 230 by an angle 375 which lies in a plane orthogonal to the longitudinal axis of cylinder 280. Although not explicitly shown in FIG. 7, the injector angle of injector-igniters 120 in cylinder head 300 is less than 90 degrees, similar to injector-igniters 120 of cylinder head 100. Similar to cylinder head 100, the bodies of injector-igniters 120 may project radially outwardly of cylinder head 300.

By angling injector-igniters 120 away from the center of combustion chamber 270 (i.e. angle 375 is greater than zero), the overall coverage of fuel jet/combustion patterns 326 across piston 230 is increased. Furthermore, such a configuration may induce swirl patterns of combustion thereby improving mixing of fuel and air within combustion chamber 270 and improving overall emissions and/or heat distribution within combustion chamber 270. Varying angle 375 further allows for injector-igniters 120 to be accommodated in a wide range of existing engines with different cylinder head designs, while optimizing the balance of the combustion, performance, efficiency and reliability within cylinder 280.

While FIG. 2 depicts cylinder head 100 as having two injector-igniters 120, in addition to one diesel fuel injector 110, there can be any number of injector-igniters 120 although in some cases, the number of injector-igniters 120 is limited by space. As the number of injector-igniters 120 provided in cylinder head 100 increases, the volume of fuel to be delivered by each injector-igniter 120 decreases allowing the size of each injector-igniter to decrease, at least until a certain point. Alternatively, the amount of fuel to be delivered by each injector-igniter 120 may decrease, thereby improving overall reliability and allowing for later injection of fuel into combustion chamber 270, thereby reducing premature ignition (knocking). This may be beneficial for fitting injector-igniters 120 into small cylinder heads or cylinder heads having minimal free space. It may be advantageous to have multiple injector-igniters since the engine may be able to continue to operate remaining injector-igniters if one or more injector-igniters fails.

FIG. 8 depicts an example cylinder head 400. Comparison of FIGS. 6 and 8 will reveal that cylinder heads 100, 400 may be structurally similar except for the number of injector-igniters 120. In particular, cylinder head 400 has four injector-igniters 120 as opposed to two injector-igniters 120.

As illustrated in FIG. 8, in cylinder head 400 injector-igniters 120 are located around central diesel fuel injector tip 115 and between valves 140. The elliptical cross-section of fuel jet/combustion patterns 426 may cover a larger cross-sectional area of combustion chamber 270 as compared to embodiments having fewer injector-igniters. In another embodiment, one or more injector-igniters 120 are mounted parallel to diesel fuel injector 110 (e.g. have injector angles 260 of 90 degrees).

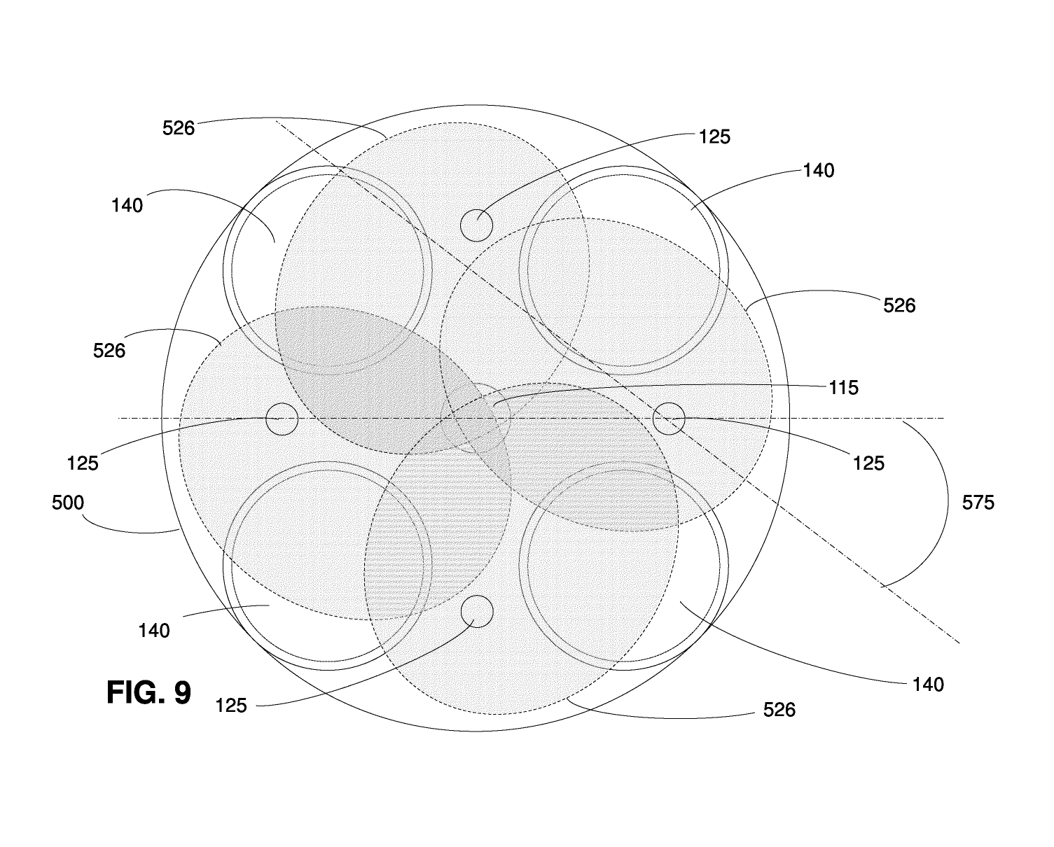

FIG. 9 depicts another example cylinder head 500. Comparison of FIGS. 8 and 9 will reveal that cylinder heads 400, 500 may be structurally similar except for the angles of injector-igniters 120. In particular, in cylinder head 500 injector-igniters 120 are angled away from the center of combustion surface 135 by an angle 575, which lies in a plane orthogonal to the longitudinal axis of cylinder 280. Although not explicitly shown in FIG. 9, the injector angle 260 of injector-igniters 120 in cylinder head 500 is less than 90 degrees. Similar to cylinder head 100, as illustrated in FIG. 2 bodies of injector-igniters 120 may project radially outward from cylinder head 500.

By angling injector-igniters 120 away from the center of piston 230 (i.e. angle 575 is greater than zero), the overall coverage of fuel jet/combustion patterns 526 across piston 230 is increased. Furthermore, such a configuration may yield swirl patterns of combustion thereby improving overall emissions and/or heat distribution within combustion chamber 270. Varying angle 575 further allows for injector-igniters 120 to be used in a wide range of existing engines with different cylinder head designs, while optimizing the balance of the combustion, performance, efficiency and reliability within the cylinder. Given that a large proportion of a cross-sectional area of piston 230 is covered by fuel jet/combustion patterns 526, combustion in combustion chamber 270 of fuel introduced by injector-igniters 120 may be superior to the combustion of diesel fuel injected through diesel fuel injector tip 115. Accordingly, cylinder head 500 may improve engine efficiency while maintaining a lower peak temperature, reducing emissions and increasing performance and power output of the engine in which cylinder head 500 is installed.

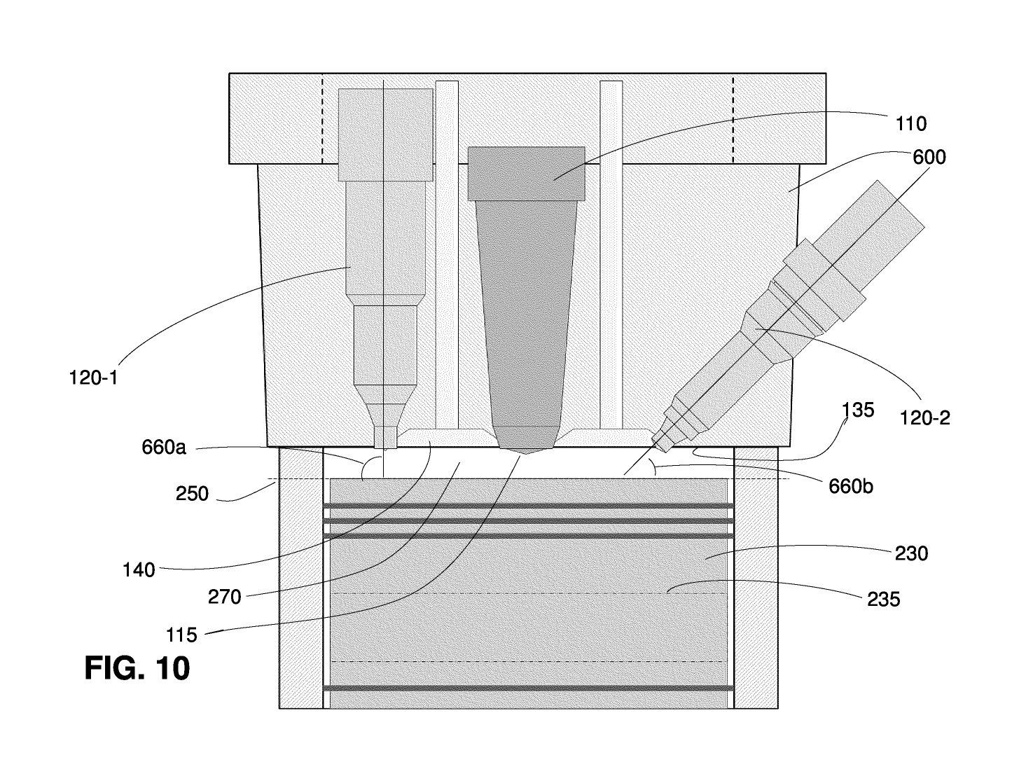

FIG. 10 depicts another example cylinder head 600. Comparison of FIGS. 4 and 10 will reveal that cylinder heads 100, 600 may be structurally similar except for injector angles 260, 660a and 660b.

In cylinder head 600, injector-igniter 120-1 is mounted so that its body extends generally parallel to diesel fuel injector 110. In this configuration, injector-igniter 120-1 will not interfere with injector-igniters of an adjacent cylinder head. Injector-igniter 120-2 is mounted at an angle 660b which may result in the body of injector-igniter 120-2 projecting radially from cylinder head 600. This arrangement of injector-igniters 120-1 and 120-2 may be necessary or desirable to prevent interference with other structures within or outside of cylinder head 600 and/or desirable to provide an improved pattern of injected fuel.

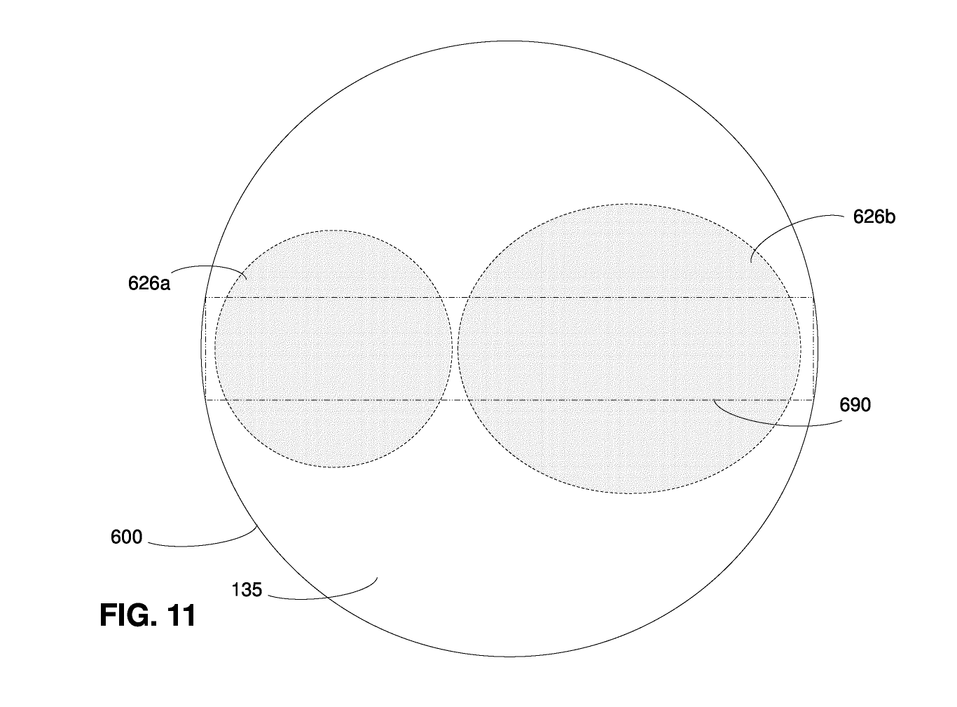

Injector angle 660b may be in the range of 0 to 90 degrees. As depicted in FIG. 11, in some embodiments, injector-igniters 120-1, 120-2 are mounted so that their tips 125 are in line with the tip 115 of diesel fuel injector 110 and form a line parallel with piston wrist pin 690, which connects piston 230 with its connecting rod. Injector-igniters 120-1, 120-2 are mounted so as not to interfere with intake and exhaust valves 140 or piston 230 at top dead center 250.

FIG. 11 depicts fuel jet/combustion patterns 626a, 626b produced by injector-igniters 120-1, 120-2. Fuel jet/combustion patterns 626a, 626b are cross-sections, taken in a plane that is orthogonal to the longitudinal axis of cylinder 280, of the jet produced by injector-igniters 120-1, 120-2. Since injector-igniter 120-1 has injector angle 660a equal to approximately 90 degrees (i.e. injector-igniter 120-1 is substantially parallel to the axis of cylinder 280), injector-igniter 120-1 produces fuel jet/combustion pattern 626a having a substantially circular cross-section in the plane of FIG. 11. Since injector-igniter 120-2 has injector angle 660b less than 90 degrees, injector-igniter 120-2 produces a fuel jet/combustion patter 626b having a substantially elliptical cross-section in the plane of FIG. 11. By arranging injector-igniters 120-1, 120-2 in line parallel to piston wrist pin 690, fuel jet/combustion patterns 626a, 626b, whether circular or elliptical in cross-section, are balanced such that the forces applied to piston 230 during combustion of the injected fuel do not put undue stress on piston 230 or other engine components and can thus transmit the fuel energy efficiently and smoothly within the combustion chamber 270.

The above embodiments are described as employing injector-igniters having generally conical jet patterns that are directed along longitudinal axes of the bodies of the injector-igniters. This is not mandatory. Some injector-igniters may, by virtue of their design, produce jets that are elliptical or have another non-circular shape in cross section. By using such injector-igniters, one can achieve fuel jet/combustion patterns that provide good distribution of force on a piston and good coverage of the combustion chamber volume using injector-igniters 120, mounted parallel or nearly parallel to the axis of a cylinder. Furthermore, it is possible to angle tips of injector-igniters to provide angled fuel jet/combustion patterns without angling the bodies of the injector-igniters.

Accordingly, the physical design of injector-igniter tip, the angle(s) of the nozzle(s) in injector-igniter tip, or some other design criteria can affect the resultant fuel jet/combustion pattern. In this case the final fuel pattern within the combustion chamber will be determined by the locations and angles of the injector-igniters. Different jet patterns may be used to compensate for asymmetric arrangements of injector-igniters (that may be required to allow injector-igniters to avoid interfering with other components in a cylinder head) to provide a symmetric or near symmetric fuel jet/combustion pattern. Any of the embodiments described herein can employ injector-igniters having various jet patterns.

In some embodiments, injector-igniters may be installed so that they pass through a cooling channel in a cylinder head. The cooling channel may carry a circulating coolant. Cylinder heads in some large diesel engines have multiple levels of cooling channels. Usually, a cooling channel is provided just above the bottom of the cylinder head. This cooling channel forms a thermal barrier between the rest of the cylinder head and the combustion chamber. Injector-igniters may be installed through one or more of the cooling channels. This has a positive consequence of cooling the injector-igniter itself close to the injector-igniter tip which is exposed to the heat in the combustion chamber. Design details for mounting injector-igniters through cooling channels will depend on the design of the cylinder head as well as the design of the injector-igniter. In some embodiments the injector-igniter extends through a sleeve which separates the injector-igniter from the cooling channel. In some embodiments high-temperature and/or high-pressure O-rings or seals, may be used.

In some embodiments, it may be beneficial to use pistons having particular features. For example, the crown of a piston may be made concave to reduce the compression ratio. This may be desirable to reduce engine knock with some fuels while at the same time helping to keep the injected fuel/air “bubble” away from the cylinder walls to minimize heat loss.

For certain liquid fuels, a convex or peak shape in the crown of the piston can help to distribute hard-to-disperse liquid fuels better throughout the combustion chamber. Piston modifications may be made to adjust compression ratios, heat and force distributions and other reasons.

Some embodiments provide methods for retrofitting an engine system to operate with one or both of two different types of fuel. As noted above, cylinder heads 100, 200, 300, 400, 500, 600 and cylinder heads having a combination of the above-described features can be retrofitted to pre-existing internal combustion engines such as diesel engines. Such cylinder heads may be created by modifying cylinder heads that are ‘stock’ for the engine or by manufacturing new cylinder heads that are a direct replacement for the stock cylinder heads, for example.

Retrofitting a pre-existing engine may include a number of steps including, installing cylinder heads as described herein, installing additional sensors, installing an additional fuel tank and fuel lines, and installing a control system. In some embodiments, additional emissions reduction systems may be installed as part of a retrofit. For example, the cylinder heads herein may be installed in conjunction with a selective catalytic reduction (SCR) system, diesel particulate filters (DPF), or other emission reduction systems and techniques as are known in the art. In many cases such additional systems will not be required since natural gas is a very clean-burning fuel compared to diesel fuel. Where particulate filters are provided, such filters may last much longer between regeneration cycles when natural gas or another clean-burning fuel is being used than would be the case where the engine runs entirely or partly on diesel fuel.

A cylinder head may be modified by boring or otherwise forming passages extending into the combustion chamber which are dimensioned to receive injector-igniters that are oriented and positioned as described above. As noted above, it is beneficial to avoid altering the original diesel fuel system of an engine. Therefore, some embodiments leave the stock diesel fuel injector in its stock location so that when running on diesel fuel the performance of the engine is essentially identical to the performance of a stock engine.

In typical low- and medium-speed diesel engines a diesel fuel injector is located in the center of the cylinder head. Therefore, in some embodiments, passages for receiving injector-igniters for an alternative fuel are bored off-axis in the cylinder head. In some embodiments such passages are formed to emerge from side surfaces of the cylinder head. Reinforcing material, such as sleeves, may be used to reinforce the cylinder head to make up for the loss of material. Seals may also be employed to ensure the combustion chamber is sealed properly and any affected cooling systems are also sealed properly.

In some cases, existing injectors may need to be relocated or paired with injector-igniters in a manner that requires a re-design of the cylinder head and related components. However, for most low- and medium-speed diesel engines, especially the vast majority which have a single injector at or near the center of the cylinder head, the cylinder heads are amenable to modifications to accept a plurality of injector-igniters as described herein.

Some larger diesel engines use a “power assembly” design where each individual cylinder assembly is made up of a piston, cylinder, and cylinder head that can be independently removed from the engine. As such, there is a physical space in the engine between each of these power assemblies, such as is illustrated in FIG. 12. In such engines, injector-igniters may project into these spaces between adjacent power assemblies.

FIG. 12 depicts one configuration of a plurality of cylinder heads 700 wherein injector-igniters 720 are interleaved. As shown in FIG. 12, by arranging injector-igniters 720 at angles to a centerline 721 of a bank of cylinders, multiple injector-igniters 700 are mounted in cylinder head 700 without physically interfering with injector-igniters from adjacent cylinders. Interleaving may be applied with some side mounted injector-igniters since there is not always enough room between cylinder heads of diesel engines to mount two injectors across from each other.

As mentioned above, for some cylinder heads injector-igniters can be mounted in such a way that they do not project on any side of the cylinder head. For example, injector-igniters may project from the top of the cylinder head or, in some cases, may be contained within the cylinder head. FIG. 3 shows an example embodiment in which injector-igniters 120 are oriented so that they project at the top of the cylinder head. In this case there must be clearance above the top of the cylinder head for each injector-igniter 120 as well as fuel and control lines connected to the injector-igniter 120.

The embodiments described above include diesel fuel injectors 110. While many commercially important embodiments provide engines which can run on diesel fuel and an alternative fuel, it is not mandatory that all embodiments run on diesel fuel. In some embodiments diesel fuel injectors 110 are replaced with fuel injectors configured and applied to inject a fuel other than diesel fuel. In some but not all such embodiments the other fuel is a liquid compression-ignition fuel other than diesel fuel.

### Control Modalities

In some advantageous embodiments, an engine as described herein has two operating modes. In a first mode the engine runs on diesel fuel or another suitable compression-ignition fuel only. In a second mode the engine runs on natural gas (or another alternative fuel) only.

Other modes may optionally be provided in which a combination of both diesel fuel injectors and alternative fuel injector-igniters are operated together.

In some embodiments diesel fuel or another compression-ignition fuel is delivered by way of an injector-igniter (e.g. diesel fuel injector 110 may be replaced by an injector-igniter or else diesel fuel may be delivered by way of one or more injector-igniters 120 in some cases). There are some advantages that can be gained by delivering fuel to the combustion chambers through the injector-igniters rather than through the traditional diesel fuel injectors. These include more precise control over the timing of ignition. For example, multiple smaller ignition bursts may be delivered in each combustion cycle. This may increase fuel efficiency and/or reduce NOx emissions by managing to keep peak combustion temperatures below the threshold at which large amounts of NOx emissions are created.

A further alternative is to operate diesel fuel injectors 110 and the injector-igniters 120 together, blending fuels. A yet further alternative is to operate diesel fuel injectors 110 and injector-igniters, with the ignition feature of the injector-igniters not switched on such that diesel fuel injector 110 acts as a pilot fuel injector while the injector-igniters 120 operating in injector-only mode serve to deliver the alternative fuel to the combustion chambers. Combustion of the alternative fuel may be initiated by combustion of the diesel fuel.

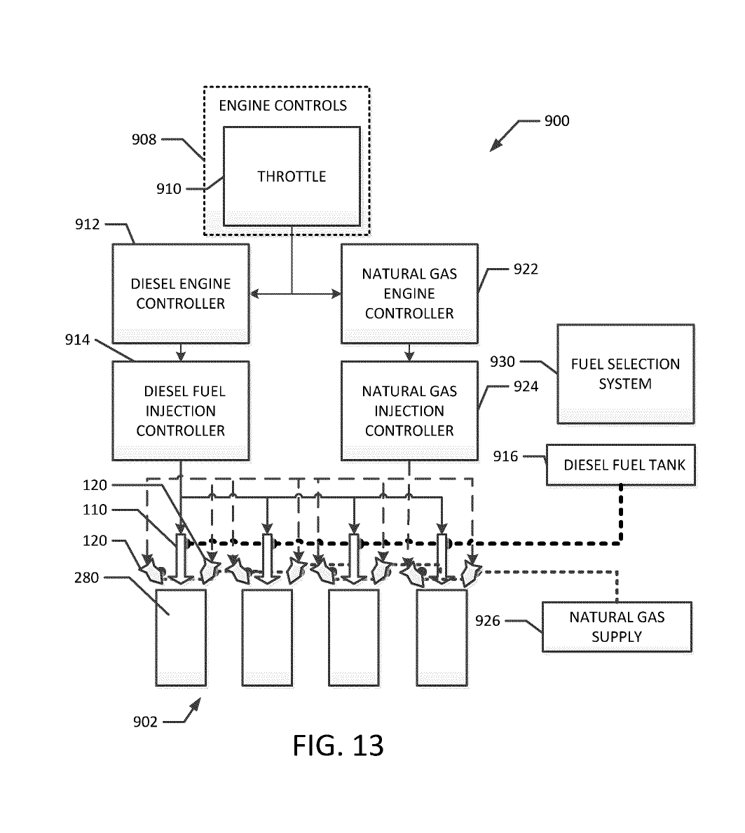

FIG. 13 illustrates an engine system 900 comprising an engine 902 according to an example embodiment. The illustrated engine 902 has four cylinders 280. However, any number of cylinders 280 may be provided.

Each cylinder 280 has at least one diesel fuel injector 110 controlled by a first injection control system. In the illustrated embodiment each cylinder 280 has one diesel fuel injector 110 that directly injects diesel fuel originating from a diesel fuel tank 916 into the cylinder 280 under control of a diesel fuel injection controller 914. Each cylinder 280 also has at least one injector-igniter 120 controlled by a second injection control system. In the illustrated embodiment, each cylinder 280 has two injector-igniters 120 that directly inject an alternative fuel—in this case, natural gas that originates from a natural gas supply 926—into the cylinder 280 under control of a natural gas injection controller 924. Controller 924 may also control ignition of injected fuel by regulating application of ignition energy from a high voltage electrical energy source to an igniter component of injector-igniters 120.

In some embodiments two or more sets of injectors are provided for the alternative fuel. Each set may include one or more injectors. The first set of injectors may comprise injectors 125A that operate at relatively low pressures. The second set of injectors may operate at relatively higher pressures. The second set of injectors may optionally comprise one or more injector-igniters. In a mode where the alternative fuel is being used (the alternative fuel may comprise natural gas for example) a portion of the alternative fuel is introduced by the first set of injectors at a relatively low pressure. The remainder of the alternative fuel for a cycle is introduced by the second set of injectors (e.g. injector-igniter 120) at a higher pressure. A pressure booster may increase the pressure of the alternative fuel being supplied to the second set of injectors. A controller may control the operation of the first and second sets of injectors such that the first set of injectors injects fuel earlier in a cycle when pressures are lower and the second set of injectors injects more of the fuel later in the cycle. The controller may adjust operation of the first set of injectors such that the amount of fuel introduced by the first set of injectors is lower than a knock threshold. The controller may control an igniter (either integrated in an injector-igniter or a separate igniter such as a laser igniter) to initiate combustion after injection of the fuel by the first set of injectors.

As pressure increases within a combustion chamber, the voltage required for a traditional spark igniter and the spark energy requirement increases. In contrast, laser ignition is improved at higher pressure. Operating at higher pressure within the combustion chamber may further allow for increased thermal efficiency that would not be obtainable using traditional spark igniters.

A fuel selection system 930 determines whether the engine runs on diesel fuel or natural gas. Such a selection system may be used to switch between fuels under different circumstances. In an example embodiment engine system 900 normally runs on natural gas. In the event of a problem with the natural gas fuel injection system or a lack of availability of natural gas fuel selection system 930 may operate or be operated to switch engine 902 to run on diesel fuel.

In some embodiments fuel selection system is used to switch between fuels depending on the current operating status or load on engine 902. For example, while engine 902 is idling engine 902 may be run on natural gas or another alternative fuel. When engine 902 is being run at higher operating speeds, then fuel selection system 930 may operate or be operated to switch engine 902 to run on diesel fuel.

In another example embodiment, while engine 902 is operating under low-load conditions engine 902 may be run on natural gas or another alternative fuel. When engine 902 is being run under higher load conditions, then fuel selection system 930 may operate or be operated to switch engine 902 to run on diesel fuel.

Fuel selection system 930 may be controlled manually and/or may be constructed to operate automatically. In some embodiments, fuel selection system 930 comprises valves to shut off the supply to engine 920 of fuel of the type that is not currently in use. Fuel selection system 930 may also shut down, place into a standby mode or otherwise disable a control system associated with the fuel that is not currently in use. In some embodiments, fuel selection system is connected to control valves that positively shut off the supply to engine 902 of the type of fuel that is not currently in use.

In some embodiments, fuel selection system 930 can automatically switch between a first fuel type and a second fuel type. This switch may occur based on fuel efficiency, fuel levels, power requirements or other factors. In other embodiments, switching between fuel types may require manual input. In further embodiments still, switching between fuel types may involve a combination of automatic and manual operations. For example, fuel selection system 930 may alert an operator when it may be beneficial to switch and the operator may make the final decision of whether or not to switch between fuel types. In some embodiments, one fuel type is merely a backup to be used in cases of emergency, such as when no fuel of the other type remains or an injector-igniter or other component fails. In such a case, fuel selection system 930 may only allow the operator to switch to the backup fuel supply if the primary fuel system fails. Such a system may be useful to ensure compliance with emissions regulations which may require engine 902 to run using natural gas or another clean fuel except in a case where this is not possible.

In some embodiments fuel selection system 930 inhibits the ability to switch fuel types unless certain specified conditions occur. For example, fuel selection system 930 may detect whether engine 902 is capable of operating on natural gas from natural gas supply 926. If so, fuel selection system 930 inhibits switching to operate on another fuel (e.g. diesel fuel). On the other hand, if engine 902 is not capable of operating on natural gas because the supply of natural gas is too low or there is a malfunction in the natural gas fuel system then fuel selection system 930 may permit switching to operate on diesel fuel. System 930 may optionally include a log which tracks when switching is performed and the number of hours of run time on each fuel. Such a log may be useful for demonstrating compliance with emissions regulations.

As shown in FIG. 13, engine system 900 may provide separate engine control systems for the different fuels. A diesel engine controller 912 and a natural gas engine controller 922 are shown. These engine controllers may control all aspects of operation of engine 902 including, for example, the timing and amount of fuel to be injected, the timing of fuel ignition by an igniter, the amount of energy that is applied to pressurize and ignite the delivered fuel, air supply to the engine, exhaust gas recirculation (EGR) etc. Each controller 912, 922 may include fuel injection maps that take into account the fuel in association with which the controller is used. Control variables such as the timing of fuel injection and ignition events may be optimized for each alternative fuel selection. For example, to avoid engine knock (premature ignition) when running on natural gas or a similar fuel it may be beneficial to inject the fuel relatively late near the end of the cycle (i.e. when the piston is near top dead center or even after top dead center).

Accordingly, an engine system 900 may provide an excellent combination of power, performance, efficiency and reliability, as closely comparable as possible to that of the traditional diesel engine running in its normal diesel fuel mode while minimizing costs and emissions.

Providing separate controllers 912, 922 permits appropriate control of engine 902 to develop the required power and to manage emissions when running on either of two very different fuels. Diesel engine controller 912 may comprise a stock diesel engine controller for engine 902 in cases where engine 902 is also supplied in a diesel-only configuration. Providing separate controllers 912, 922 also introduces redundancy for more reliable operation. Further, engine controllers 912, 922 are individually simpler since each of these engine controllers may be configured to control operation of engine 902 on a single fuel.

To improve efficiency, reliability and power, each engine controller 912, 922 may have inputs from a number of sensors which sense engine conditions. For example sensors may be installed to monitor temperature and pressure within the combustion chamber and/or fuel lines, to monitor premature ignition (knocking) and to monitor emissions such as NOx, CO, and/or CO2 and other greenhouse gases. The data obtained by the sensors may be used to optimize injection parameters such as the timing, injection duration and/or flow rate of fuel injection. In the case of controller 922, the timing of operation of an igniter in injector-igniters 120 may be controlled based in part on feedback from sensors in engine 902. In some embodiments, sensors such as cylinder temperature, cylinder pressure and/or fuel injection flow rate sensors are included in injector-igniters 120. The design of engine controllers and their associated sensors is well understood by those skilled in the art and is therefore not described here.

In the illustrated embodiment, outputs from engine controls 908 including a throttle 910 are provided to each of engine controllers 912, 922. From the perspective of an operator of engine 902 the task of operating engine 902 may be the same regardless of what fuel engine 902 is currently running.

It is not required that the alternative fuel be natural gas. In some embodiments the fuel to be used with injector-igniters 120 is methanol, reformed methanol, an alkane fuel (e.g. ethane, propane, butane up to and including liquid pentane, hexane etc.), syngas, biodiesel fuel, biofuels or blends of the above. In further embodiments still, heavy fuel oils or coal derivatives may be used.

In railroad applications a fuel tank or tanks for an alternative fuel (e.g. natural gas supply 926) may be installed on board a locomotive and/or in a fuel tender. The fuel supply may be connected to engine 902 via suitable piping, valves, regulators, and heat exchange systems as required to deliver the fuel at a suitable temperature, flow rate and pressure.

Especially in cases where the alternative fuel comprises natural gas or another flammable gas, an engine system may include gas sensors configured to detect leaks of the fuel. The gas sensors may trigger a valve to automatically shut off a supply of the fuel if a leak is detected.

Some embodiments provide a special mode of operation of injector-igniters 120 in configurations where there is more than one injector-igniter 120 per cylinder. In such embodiments, fewer than all of the injector-igniters are used to inject fuel in each cycle of engine 902 for some engine operating conditions (e.g. in idle, low speed and/or low load conditions). For example, in a cylinder in which there are two injector-igniters 120, only one injector-igniter may be used to inject and ignite fuel on each power stroke. The two injector igniters may be operated on alternating power strokes. Where the particular injector-igniter that is used on each power stroke alternates each injector-igniter may wear at the same rate.

Inhibiting operation of some injector-igniters 120 on power strokes where sufficient fuel can be supplied by fewer than all of the available injector-igniters reduces the number of times the injector-igniters are cycled, thereby increasing the life expectancies of the injector-igniters and the overall engine reliability. This mode may be initiated automatically when engine 902 is idling or operating in low speed/load conditions. Since many locomotives spend a great deal of their time at idle, the number of injection-ignition cycles during idle can be very large even though the engine may be running at a very low RPM when at idle. Alternatively or additionally, there can be a manual way to initiate this mode.

By way of example, for a locomotive operating in a typical line-haul duty cycle, operating in a mode in which two injector-igniters each operate for one half of the injection-igniter cycles when the locomotive is idling would only require an average of 22,539 injection-ignition cycles per hour as compared to 26,940 injection-ignition cycles that would occur if both injector-igniters were operated on every power stroke. This cycle difference would increase the expected life of the injector-igniters by as much as 20%.

In some embodiments, having higher pressure ignition system and a lower pressure ignition system, the controller may be configured to control the volume of gaseous fuel introduced by the higher- and lower-pressure injection systems such that a desired total volume of the gaseous fuel is injected each cycle. In some embodiments the controller causes the lower-pressure injection system to inject more of the gaseous fuel than the higher-pressure injection system. In some embodiments the controller causes the lower-pressure injection system to inject 35 to 70% of the total gaseous fuel in each cycle. In some embodiments the controller causes the lower-pressure injection system to limit the amount of injected gaseous fuel to a level lower than a knock threshold (the knock threshold is the amount of gaseous fuel above which significant knock may occur). The controller may control the amount of gaseous fuel injected by the higher-pressure injection system to avoid knock problems.

While engine system 900 is designed to permit operation of engine 902 on either diesel fuel or an alternative fuel such as natural gas, in other embodiments a control system may be provided that has at least one operating mode in which both fuels are delivered to engine 902. Such a control system may be in addition to or as a substitute for engine control systems 912 and 922.

In some embodiments a controller for injector-igniters 120 may detect failure of an injector-igniter in a cylinder and may compensate for that failure by changing the operation of other injector-igniters in the cylinder. For example, the controller may disable the failed injector-igniter (e.g. by closing a valve that supplies fuel to the injector-igniter) and may increase the amount of fuel delivered by the other injector-igniters in that cylinder or by one or more other fuel injectors in that cylinder (e.g. by increasing a duration of one or more fuel injection pulses or increasing a number of fuel injection pulses).

### Example Applications

The technology described herein may be applied to operate engines using various fuels in a wide variety of applications including but not limited to rail, marine, oil and gas and industrial applications. The technology is particularly suited to large-displacement low- and medium-speed engines (e.g. engines which operate in the range of 100 to 1500 rpm) but also may be applied to other engines such as higher-speed engines.

Some specific examples of diesel engines that can be retrofitted using some or all of the above features include the American Locomotive Company Alco 251, the General Motors EMD 645 family, the General Motors EMD 710 family, and the General Electric 7FDL series.

A range of advantages may be gained by using the technology described herein although the technology is not tied to any particular advantages. Converting to alternative fuels, while still maintaining the ability to switch back to 100% diesel fuel operation and maintaining the traditional levels of power, performance, efficiency and reliability, is a very attractive option for the thousands of 10 to 20 year old locomotives in use worldwide. The fuel saving that may be obtained by using alternative fuels can more than offset the cost of rebuilding these older locomotives to incorporate one or more embodiments of this disclosure. In addition, by running existing engines on cleaner-burning fuel such as natural gas, emissions can potentially be reduced significantly from the original locomotive configuration, potentially rivaling or equaling the emissions from the newest and cleanest available diesel fuel locomotive engines.

In marine applications it may be beneficial to switch engines to cleaner fuel sources in areas such as ports near large coastal cities where it is important to reduce air pollution. Traditional fuels may be used on the high seas. In oil and gas applications, some of the aspects described herein offer improved means to burn various side products at or near the well sites in engines that may be used for example to extract, compress, refine or transport the various petrochemical products produced by the wells.

While a number of example aspects and embodiments are discussed herein, those of skill in the art will recognize certain modifications, permutations, additions and subcombinations thereof. For example:
While the description herein refers to diesel fuel injectors, in some embodiments these injectors may be injectors for a different type of fuel. Examples of other fuels are at least: methanol, reformed methanol, alkane fuels including ethane, propane, butane up to and including liquid pentane, hexane etc., syngas, biodiesel fuel, biofuels or blends of the above. In further embodiments still, heavy fuel oils or coal derivatives may be used.
Where a number of injectors are provided to inject a low cetane fuel (e.g. natural gas) into an engine it is not necessary that all of the injectors are injector-igniters. In some embodiments less than all of the injectors are injector-igniters. In such embodiments, fuel ignited by an injector-igniter ignites fuel from other injectors. In some embodiments the other injectors comprise lower-pressure gaseous fuel injectors 125A.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

In this description and the accompanying drawings certain elements are referred to using the same reference number. For example, injector-igniters are referred to using reference number 120, diesel fuel injectors are referred to by reference number 110, and so on. The use of the same reference number does not require all components referenced by that number to be the same. For example, in some embodiments having two injector-igniters 120 the two injector-igniters may optionally differ from one another in one or more respects. Also, injector-igniters 120 in different embodiments may be the same or different. Many variations in the construction of injector-igniters 120, diesel fuel injectors 110, cylinder head geometry and features, piston geometry and features etc. may be found in different embodiments. Similarly, different reference numbers applied to similar components permit but do not require the components to differ from one another in respects other than what is described. For example, cylinder heads 100, 200, 300, 400, 500, 600, and 700 are described. These cylinder heads differ from one another primarily in the arrangements of injector-igniters provided. In other respects the described cylinder heads may be the same or different from one another. Optional lower-pressure gaseous fuel injectors 125A are illustrated in FIG. 2. Any other described embodiment may optionally include one or more appropriate lower-pressure fuel injectors 125A.

Reference is made to various controllers. Such controllers may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained herein and/or combinations of two or more of these. Commercially available engine controllers as known to those of skill in the art may be applied. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, general purpose computers, and the like. For example, one or more data processors in an engine controller system may implement methods as described herein by executing software instructions in a program memory (e.g. a suitable read only memory (ROM) accessible to the processors.

Where a component (e.g. a cylinder head, valve, injector, controller, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While the invention has been disclosed in its preferred form, the specific embodiments thereof as disclosed herein are not to be considered in a limiting sense, because numerous variations are possible. The subject matter of the invention includes all novel and non-obvious combinations and subcombinations of the various elements, features, functions, and/or properties disclosed herein. No single feature, function, element, or property of the disclosed embodiments is essential. The following claims define certain combinations and subcombinations which are regarded as novel and non-obvious. Other combinations and subcombinations of features, functions, elements, and/or properties may be claimed through amendment of the present claims or presentation of new claims in this or a related application. Such claims also are regarded as included within the subject matter of the present invention irrespective of whether they are broader, narrower, or equal in scope to the original claims. This invention also covers all embodiments and all applications which will be immediately comprehensible to the expert upon reading this application, on the basis of his or her knowledge and, optionally, simple routine tests. In addition, the various embodiments described above can be combined to provide further embodiments.

It is therefore intended that all claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1.-133. (canceled)

134. An internal combustion engine system comprising:
one or more cylinder heads and corresponding combustion chambers, a first cylinder head of the one or more cylinder heads comprising:
a first fuel injector connected to a first fuel supply;
a second fuel injector connected to a second fuel supply;
an igniter;
a first controller connected to at least one of the first and second fuel injectors for controlling at least a first fuel supply to a first combustion chamber of the one or more combustion chambers, the first combustion chamber corresponding to the first cylinder head;
a fuel selection system configured to operate in at least the following operating modes:
a low power mode activated when a desired power output of the engine system is below a power threshold, the low power mode comprising injecting the first type of fuel into the first combustion chamber through the first fuel injector and;
a high power mode activated when the desired power output of the engine system is above the power threshold, the high power mode comprising injecting the second type of fuel into the first combustion chamber through the second fuel injector.

135. An internal combustion engine system according to claim 134 wherein the fuel selection system is configured to operate in a hybrid mode, the hybrid mode comprising injecting the first type of fuel into the first combustion chamber through the first fuel injector and injecting the second type of fuel into the first combustion chamber through the second fuel injector in the same combustion cycle.

136. An internal combustion engine system according to claim 134 wherein the first controller is connected to control the first fuel injector for controlling the first fuel supply to the first combustion chamber and the engine comprises a second controller connected to control the second fuel injector for controlling a second fuel supply to the first combustion chamber.

137. An internal combustion engine system according to claim 136 wherein:
the first controller is connected to operate a first valve controlling the first fuel supply and is configured to close the first valve depending on the operating mode; and
the second controller is connected to operate a second valve controlling the second fuel supply and is configured to close the second valve depending on the operating mode.

138. An internal combustion engine system according to claim 134 wherein the power threshold is based at least in part on a fuel supply status.

139. An internal combustion engine system according to claim 134 wherein the power threshold is based at least in part on a fuel efficiency target.

140. An internal combustion engine system according to claim 134 wherein the second fuel injector comprises an injector-igniter.

141. An internal combustion engine system according to claim 140 wherein the first controller is configured to ignite the injector-igniter multiple times in a combustion cycle.

142. An internal combustion engine system according to claim 134 wherein the second fuel injector comprises a plurality of injector-igniters and wherein each of the plurality of injector-igniters is angled away from a center of the first combustion chamber to thereby produce a swirling fuel jet pattern.

143. An internal combustion engine system according to claim 134 wherein the first controller is configured to cause the first fuel injector to inject a relatively high volume of fuel at a relatively low pressure through the first fuel injector and then cause the second fuel injector to inject a relatively low volume of fuel at a relatively high pressure through the second fuel injector during a combustion cycle.

144. An internal combustion engine system according to claim 134 comprising one or more temperature sensors arranged to measure a temperature of the first combustion chamber and wherein the first controller is configured to switch operating modes based at least in part on the temperature of the first combustion chamber.

145. An internal combustion engine system according to claim 134 comprising one or more sensors arranged to monitor for premature ignition and wherein the first controller is configured to switch operating modes based at least in part on feedback from the one or more sensors to monitor for premature ignition.

146. An internal combustion engine system according to claim 134 comprising one or more sensors arranged to monitor emissions and wherein the first controller is configured to switch operating modes based at least in part on feedback from the one or more sensors to monitor emissions.

147. An internal combustion engine system according to claim 134 wherein the second fuel comprise a gaseous fuel and the method comprises boosting a pressure of the gaseous fuel before supplying the gaseous fuel to the second fuel injector.

148. An internal combustion engine system according to claim 147 wherein boosting the pressure comprises boosting the pressure to at least 3000 psi.

149. An internal combustion engine system according to claim 134 wherein the first controller is configured to, at a first point in a combustion cycle, operate the second fuel injector to inject a measured amount of the second fuel, the measured amount being lower than a knock threshold amount and, at a second point in the combustion cycle later than the first point, operate a third fuel injector to inject more of the second fuel.

150. An internal combustion engine system according to claim 149 wherein the first controller is configured to inject 30% to 70% of the second fuel by the second fuel injector and injecting 70% to 30% of the second fuel by a third fuel injector.

151. An internal combustion engine system according to claim 134 comprising a fuel igniter and wherein the fuel igniter comprises a laser igniter.

152. An internal combustion engine system according to claim 151 wherein the laser igniter produces a plurality of ignition beams simultaneously.

153. An internal combustion engine system according to claim 151 wherein the plurality of ignition beams exit the laser igniter at different angles.

154. internal combustion engine system according to claim 151 wherein the laser igniter produces an ignition beam that is nonparallel with a longitudinal axis of the laser igniter.
